(19) United States
(12) Patent Application Publication
(10) Pub. No.: US 2015/0100676 A1
(43) Pub. Date: Apr. 9, 2015

(54) STORAGE MEDIUM, METHOD FOR DATA PROCESSING, AND PROCESSING MANAGEMENT APPARATUS

(71) Applicant: FUJITSU LIMITED, Kawasaki-shi (JP)

(72) Inventors: Miho Murata, Kawasaki (JP); Yuichi Tsuchimoto, Kawasaki (JP); Hidekazu Takahashi, Kawasaki (JP)

(21) Appl. No.: 14/480,791

(22) Filed: Sep. 9, 2014

(30) Foreign Application Priority Data
Oct. 7, 2013 (JP) 2013-210289

(51) Int. Cl. G06F 9/38; H04L 12/24

(52) U.S. Cl. CPC G06F 9/3885; H04L 41/00
USPC 709/223

(57) ABSTRACT

A non-transitory computer-readable storage medium storing therein a program that causes a computer to execute a process includes managing a data processing by a processing target node among a plurality of nodes in which respective nodes have relations with other nodes, the processing target node being traced from a start node on the basis of the relations, and calculating a total number of nodes linked to the start node on the basis of numbers of stages indicating distances of processed nodes and the processing target node from the start node, and numbers of branches from the processed nodes and the processing target node, while the processing target node performs the data processing.

### CROSS-REFERENCE TO RELATED APPLICATION

This application is based upon and claims the benefit of priority of the prior Japanese Patent Application No. 2013-210289, filed on Oct. 7, 2013, the entire contents of which are incorporated herein by reference.

### FIELD

The embodiment discussed herein is related to a non-transitory computer-readable storage medium, a method for data processing, and a processing management apparatus.

### BACKGROUND

In recent years, the range and amount of information treated in business have remarkably increased. Data processing is performed using a large amount of data (big data) generated one after another.

As a system of processing of a large amount of data, there are, for example, a batch system and an incremental system. The batch system is a system for processing entire accumulated data. The incremental system is a system for, when new data (hereinafter referred to new arrival data) arrives, sequentially processing data related to the new arrival data. The incremental system is useful for analysis processing that makes use of the new arrival data in the large amount of data.

As a model of a parallel calculation for performing distributed processing, an actor model is known. In incremental processing for a large amount of data, for example, data is distributedly stored on a plurality of disks and related data is sequentially processed according to the actor model. In the actor model, each of calculation entities called actors performs an operation for 1) processing a received message and updating an internal state according to necessity, 2) transmitting a limited number of messages to the other actors, and 3) generating a limited number of new actors, whereby distributed processing is performed.

In recent years, processing targeting social data (social networking service: SNS, etc.) has been increasing. The social data includes, for example, as a characteristic, in relation to elements of one data (hereinafter referred to as node data), other node data. The number of related node data is different depending on node data. Data having relations among node data is described in, for example, Japanese Patent Application Laid-open No. 2008-134688.

### SUMMARY

When the large amount of data is processed in the incremental system, after generation of the new arrival data, parallel processing is applied according to an amount of the data processing in order to reduce time consumed for the data processing.

In the processing of the data having the relation among the node data such as the social data, as explained above, the number of related node data is different depending on node data. In the data processing, following start node data at a start point, node data branching from the start node data and node data branching from the node data are sequentially traced and processed. Therefore, a total number of related node data may be unable to be grasped. It is difficult to estimate an amount of the data processing.

Therefore, the parallel processing is applied to the processing of the branching node data. However, when the parallel processing is performed, generation of processes and copying of messages corresponding to the number of branches are performed. A consumed amount of resources increases. Therefore, when parallelism is enormous, depletion of resources occurs.

According to one aspect, there is provided a non-transitory computer-readable storage medium, a method for data processing, and a processing management apparatus for efficiently executing data processing.

According to a first aspect of the embodiment, a non-transitory computer-readable storage medium storing therein a program that causes a computer to execute a process includes managing a data processing by a processing target node among a plurality of nodes in which respective nodes have relations with other nodes, the processing target node being traced from a start node on the basis of the relations, and calculating a total number of nodes linked to the start node on the basis of numbers of stages indicating distances of processed nodes and the processing target node from the start node, and numbers of branches from the processed nodes and the processing target node, while the processing target node performs the data processing.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining the configuration of a parallel processing management system in an embodiment.

FIG. 2 is a diagram for explaining an example of the configuration of the parallel processing management apparatus 10 in the parallel processing management system illustrated in FIG. 1.

FIG. 3 is a block diagram of the parallel processing management apparatus in the parallel processing management system illustrated in FIG. 1.

FIG. 4 is a diagram for explaining the data in which elements have relations with other elements.

FIG. 5 is a diagram illustrating a tree structure having processing target node data in the case of the processing of the data having relations among node data.

FIGS. 6A and 6B are diagrams for explaining an example of serial processing of processing of node data.

FIGS. 7A and 7B are diagrams for explaining an example of parallel processing of processing of node data.

FIGS. 8A and 8B are diagrams for explaining an application example of the parallel processing for data processing based on a total number of pieces of processing.

FIGS. 9A and 9B are diagrams for explaining an example of a reduction of a turnaround time of data processing based on a total number of pieces of processing.

FIG. 10 is a flowchart for explaining data processing executed by being triggered by data generation in the terminal apparatuses 30a to 30c illustrated in FIG. 1.

FIG. 11 is a flowchart for explaining processing of the data processing unit 22 of the incremental processing engine 21.

FIG. 12 is a diagram for explaining the overview of propagation of a message between the parallel processing management apparatuses 10 in the data processing explained with reference to the flowcharts of FIGS. 10 and 11.

FIGS. 13A and 13B are a first diagram for explaining a specific example of estimation processing for a total number of node data in this embodiment.

FIGS. 14A and 14B are a second diagram for explaining the specific example of the estimation processing for a total number of node data in this embodiment.

FIGS. 15A and 15B are a third diagram for explaining the specific example of the estimation processing for a total number of node data in this embodiment.

FIGS. 16A and 16B are diagrams for explaining transition of an estimated number of a total number of pieces of processing.

### DESCRIPTION OF EMBODIMENTS

[Configuration of a Parallel Processing Management System]

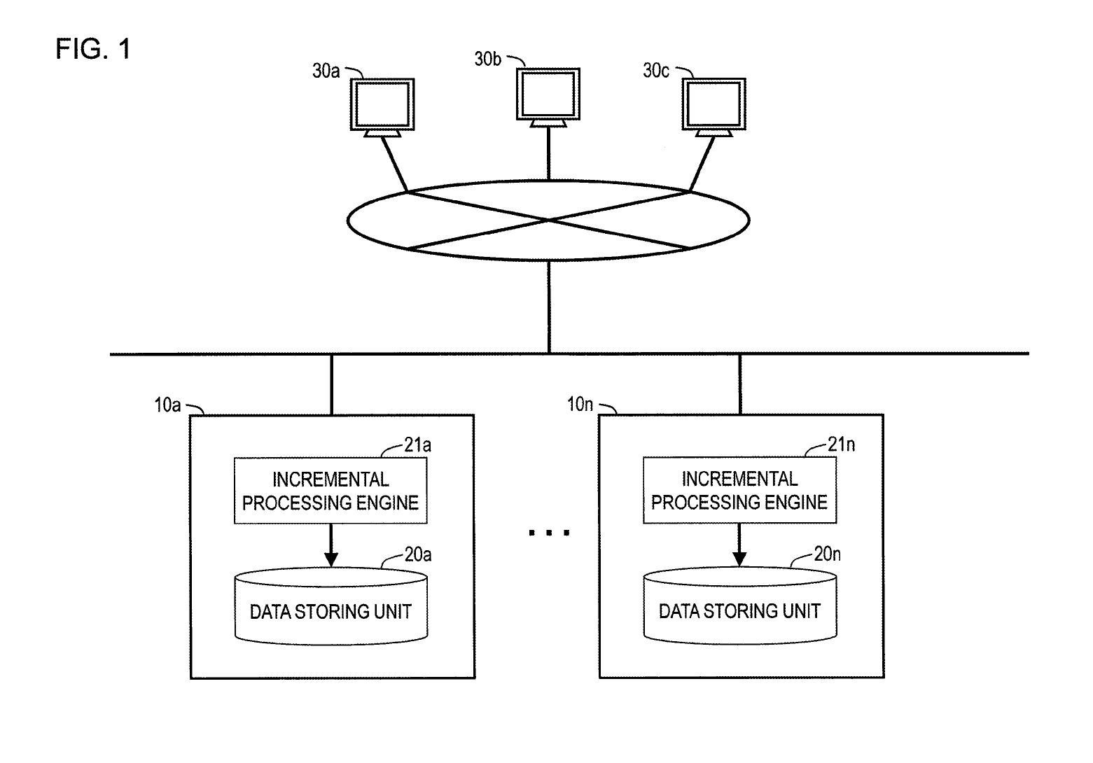

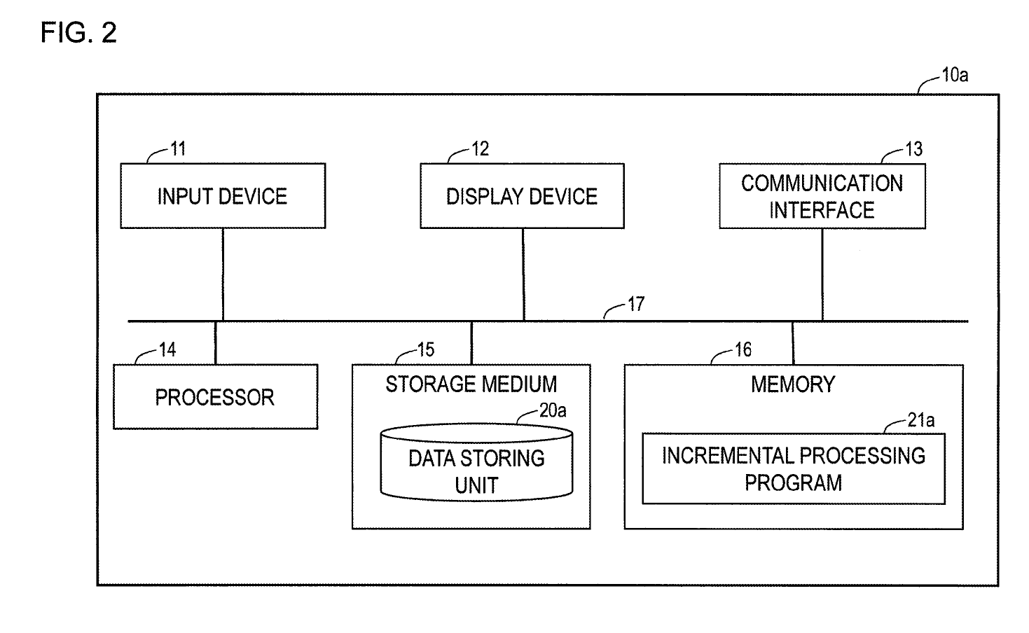

FIG. 1 is a diagram for explaining the configuration of a parallel processing management system in an embodiment. The parallel processing management system illustrated in FIG. 1 includes, for example, a plurality of parallel processing management apparatuses 10a to 10n communicable with each other. For example, each of the parallel processing management apparatuses 10a to 10n is connected to a plurality of terminal apparatuses 30a to 30c via the Internet. Each of the parallel processing management apparatuses 10a to 10n includes an incremental processing engine 21 (21a to 21n) and a data storing unit 20 (20a to 20n). The parallel processing management system in this embodiment distributedly retains processing target data in the data storing units 20a to 20n of the plurality of parallel processing management apparatuses 10a to 10n. The incremental processing engines 21a to 21n and the data storing units 20a to 20n are explained with reference to FIG. 2.

The parallel processing management system illustrated in FIG. 1 sequentially propagates, in response to new arrival data, a message indicating processing target data related to the new arrival data to the parallel processing management apparatuses 10a to 10n, which retain the processing target data, and processes the message according to an actor model.

The actor model is one of parallel calculation models and represented by a set of calculation entities called actors. The actors indicate, for example, processing processes of the incremental processing engines 21a to 21n executed by the parallel processing management apparatuses 10a to 10n. The individual actors (processing processes) behave as explained below. The actor (the processing process) transmits a limited number of messages to the other actors (processing processes). The actor (the processing process) generates a limited number of new actors (processing processes). Upon receiving a message, the actor (the processing process) processes the message and updates an internal state according to necessity.

Description will be made correspondingly to the parallel processing management system illustrated in FIG. 1. The terminal apparatuses 30a to 30c acquire, for example, data input from a user in a Web service or the like and transmit a message including data to any one of the parallel processing management apparatuses 10 (10a to 10n). When processing target data is stored in the data storing unit 20, the parallel processing management apparatus 10, which receives the message, generates a processing process and processes the data. The parallel processing management apparatus 10 generates a message including information concerning one or a plurality of data related to the processing target data and transmits the message. On the other hand, when processing target data is not stored in the data storing unit 20, the parallel processing management apparatus 10 transfers the message to the parallel processing management apparatus 10 that retains data.

[Configuration of the Parallel Processing Management Apparatus]

FIG. 2 is a diagram for explaining an example of the configuration of the parallel processing management apparatus 10 in the parallel processing management system illustrated in FIG. 1. In FIG. 2, the configuration of the parallel processing management apparatus 10a is illustrated. However, the configuration of the other parallel processing management apparatuses 10b to 10n is the same. The parallel processing management apparatus 10a illustrated in FIG. 2 includes, for example, an input device 11, a display device 12, a communication interface 13, a processor 14, a storage medium 15, and a memory 16. These units are connected to one another via a bus 17. The input device 11 indicates, for example, a keyboard and a mouse. The display device 12 indicates, for example, a display screen such as a display. The parallel processing management apparatus 10 performs communication with the terminal apparatuses 30a to 30c illustrated in FIG. 1 and the other parallel processing management apparatus 10b to 10n via the communication interface 13.

The storage medium 15 includes a data storing unit 20a. The data storing unit 20a stores processing target data and new arrival data. As explained above with reference to FIG. 1, the parallel processing management system in this embodiment distributedly retains data in the data storing units 20a to 20n of the plurality of parallel processing management apparatuses. In the memory 16, the incremental processing program (corresponding to the parallel processing management program) 21a in this embodiment is stored. The incremental processing program 21a realizes the parallel management processing of the data processing in this embodiment in cooperation with the processor 14.

[Block Diagram of the Parallel Processing Management Apparatus]

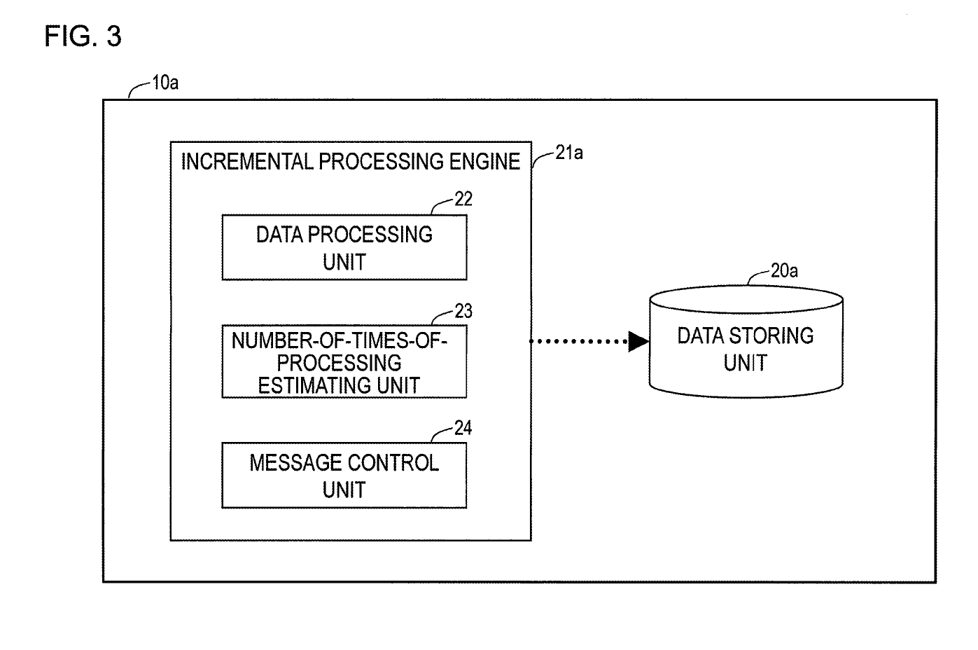

FIG. 3 is a block diagram of the parallel processing management apparatus in the parallel processing management system illustrated in FIG. 1. As in FIG. 2, in FIG. 3, the configuration of the parallel processing management apparatus 10a is illustrated. However, the configuration of the other parallel processing management apparatuses 10b to 10n is the same.

The incremental processing engine 21a of the parallel processing management apparatus illustrated in FIG. 3 includes, for example, a data processing unit 22, a number-of-pieces-of-processing estimating unit 23, and a message control unit 24. The data processing unit 22 reads out data from the data storing unit 20a on the basis of a received message. The data processing unit 22 applies predetermined processing to the read-out data and stores a processing result in the data storing unit 20a. The number-of-times-of-processing estimating unit 23 estimates a total number of pieces of processing, which indicates a total amount of data processing, on the basis of information acquired with reference to the data storing unit 20a and information included in the message. The message control unit 24 controls generation and transmission and reception of the message.

[Data Having Relations Among Elements]

Target data of the parallel processing management system in this embodiment is, for example, data in which elements of have relations with other elements. The data in which elements have relations with other elements is for example, social data (social networking services: SNS, etc.). The data having relations among elements is explained.

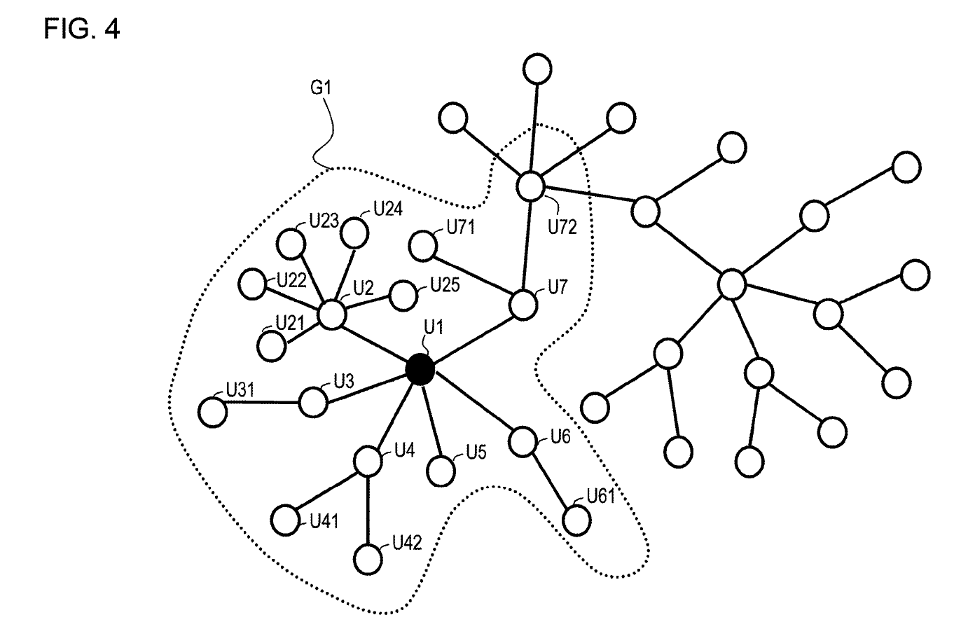

FIG. 4 is a diagram for explaining the data in which elements have relations with other elements. In FIG. 4, elements are users. Users connected by lines indicate users registered as friends each other. As illustrated in FIG. 4, users U2 to U7 are users who register a user U1 as a friend. Users U21 to U25 are users who register the user U2 as a friend. The same applies to the other users.

As illustrated in FIG. 4, the number of users registered as friends is different depending on a user. Therefore, a range of friends of friends of a user is also different depending on a user. For example, a range G1 indicates a range of friends of friends of the user U1. The range G1 includes the users U2 to U7, who are friends of the user U1, and users U21 to U25, U31, U41, U42, U61, U71, and U72, who are friends of the users U2 to U7. Therefore, for example, when data processing is performed targeting a range of friends of friends of a user, the number of processing target elements (users) is different depending on a user.

When the data having relations among elements illustrated in FIG. 4 is processed, for example, a route of elements traced by the parallel processing management system on the basis of the relation among the elements from an element at a start point (in FIG. 4, the user U1) branches halfway. Therefore, when data having relations among nodes is processed, processing target elements can be represented by, for example, a tree structure. The elements of the data are hereinafter referred to as node data.

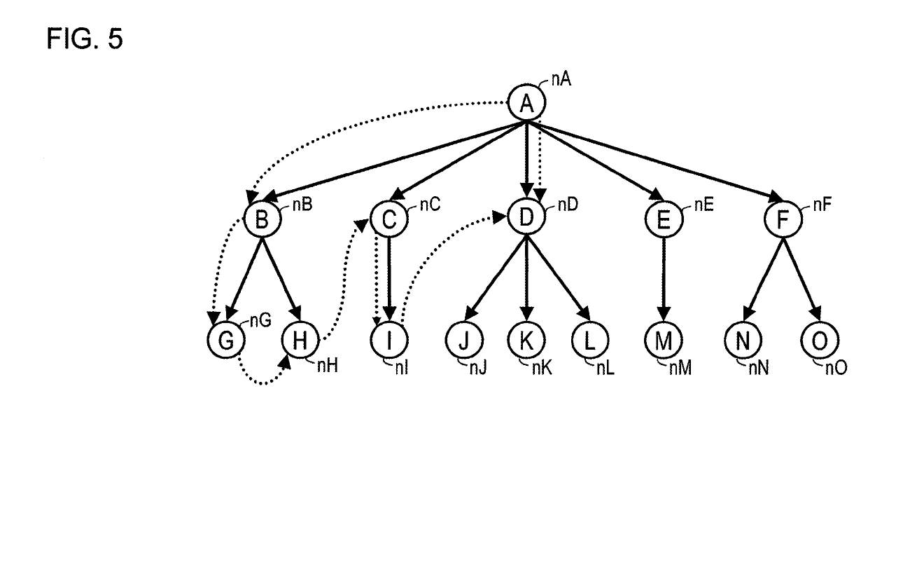

FIG. 5 is a diagram illustrating a tree structure having processing target node data in the case of the processing of the data having relations among node data. Node data AnA in the tree structure illustrated in FIG. 5 is a start node data at a start point. The start node data AnA has relations with each of node data BnB to FnF. Further, the node data BnB has relations with node data GnG and HnH. The other node data CnC to FnF have relations with one or a plurality of node data in the same manner.

For example, the parallel processing management system traces the node data having relations from the start node data using a depth-first search of the tree structure, and sequentially performs processing for the node data. That is, in an example illustrated in FIG. 5, as indicated by dotted line arrows, the parallel processing management system traces the node data AnA, the node data BnB, the node data GnG, the node data HnH, and the node data CnC in this order and performs processing.

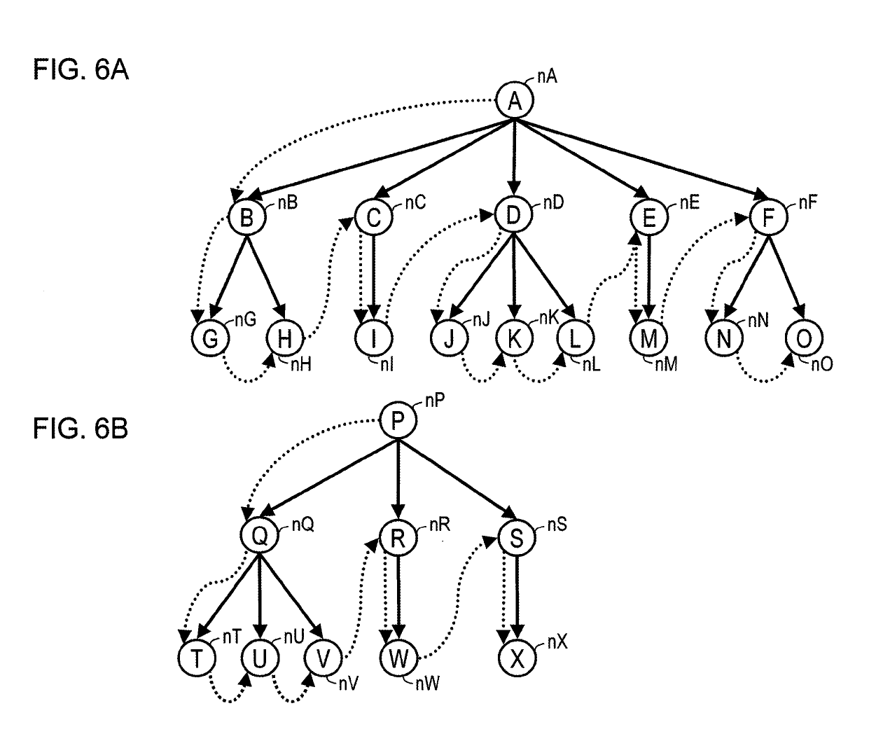

FIGS. 6A and 6B are diagrams for explaining an example of serial processing of processing of node data. A tree structure illustrated in FIG. 6A is a tree structure including fifteen processing target node data. A tree structure illustrated in FIG. 6B is a tree structure including nine processing target node data.

When fifteen node data AnA to Ono included in the tree structure illustrated in FIG. 6A are subjected to the serial processing, for example, the parallel processing management system performs processing in order indicated by dotted line arrows. Similarly, when nine node data PnP to XnX included in the tree structure illustrated in FIG. 6B are subjected to the serial processing, for example, the parallel processing management system performs processing in order indicated by dotted line arrows.

A processing time consumed for data processing is explained. As illustrated in FIGS. 1 and 2, the parallel processing management system in this embodiment stores node data in a storage medium (the data processing units 20a to 20n) such as a disk. A processing time for the node data stored in the storage medium such as a disk is equivalent to an input and output time of the storage medium. That is, the processing time for the node data is substantially fixed for all the node data. Therefore, the processing time of the data illustrated in FIGS. 6A and 6B corresponds to a total number of the node data included in the tree structure.

Specifically, when the fifteen node data AnA to Ono included in the tree structure illustrated in FIG. 6A are subjected to the serial processing, the processing time is “15”. On the other hand, when the nine node data PnP to XnX included in the tree structure illustrated in FIG. 6B is subjected to the serial processing, the processing time is “9”. In this way, the number of processing target node data is different depending on the start node data (the node data AnA or PnP). Therefore, time consumed for the data processing is also different. That is, imbalance of the processing time occurs between the data processing related to the start node data AnA and the data processing related to the start node data PnP. The parallel processing management system eliminates the imbalance of the processing time by, for example, parallelizing processing branching from the node data to thereby.

[Parallel Processing]

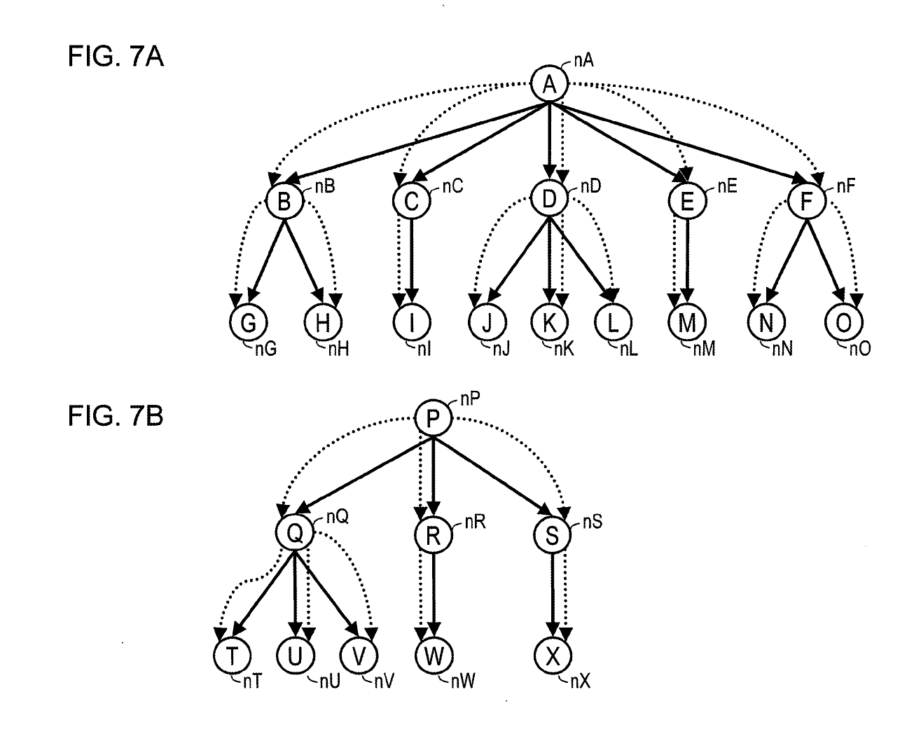

FIGS. 7A and 7B are diagrams for explaining an example of parallel processing of processing of node data. As in the example illustrated in FIG. 6, a tree structure illustrated in FIG. 7A is a tree structure including fifteen processing target node data. A tree structure illustrated in FIG. 7B is a tree structure including nine processing target node data.

In the example illustrated in FIGS. 7A and 7B, the parallel processing management system sets processing of node data branching from the node data as a target of the parallel processing. Specifically, in FIG. 7A, as indicated by dotted line arrows, the parallel processing management system parallelizes processing of the node data BnB to FnF and parallelizes processing of the node data GnG to Ono branching from the node data BnB to FnF. In this case, parallelism is 8 and a processing time is 3. For example, in FIG. 7B, as indicated by dotted line arrows, the parallel processing management system parallelizes the node data PnP to XnX. In this case, the parallelism is 5 and the processing time is 3.

As illustrated in FIGS. 7A and 7B, by parallelizing processing of a part of node data, even when a total number of processing target node data is different, it is possible to equalize the processing time consumed for data processing (in the example illustrated in FIGS. 7A and 7B, three). However, when the processing of the node data is parallelized, according to the number of parallel connections, generation of processes and copying of transmission messages occur and resources are consumed. Therefore, when the number of branching node data is enormous, it is likely that depletion of resources occurs.

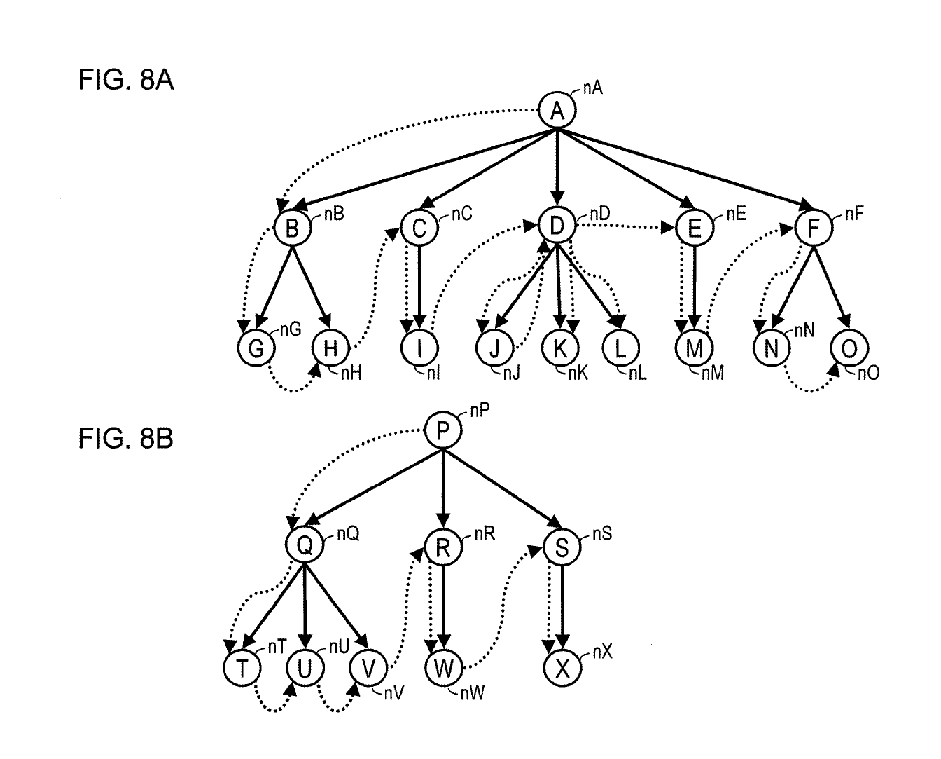

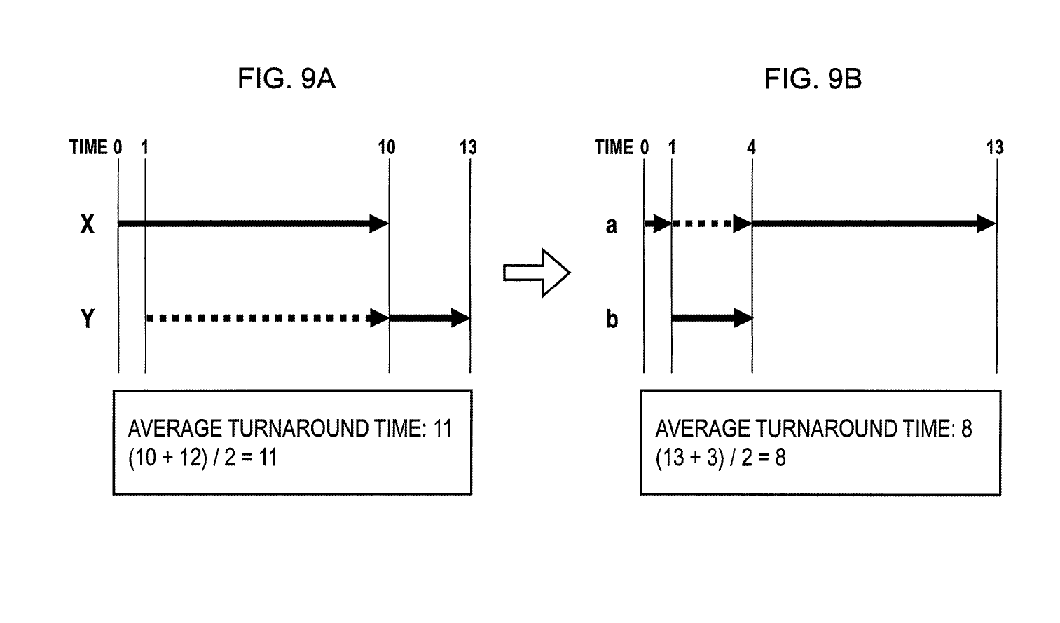

Therefore, the parallel processing management apparatus in this embodiment estimates the number of processing target node data in data processing and suppresses imbalance of the processing time. Alternatively, the parallel processing management apparatus reduces an average of turnaround times on the basis of the number remaining node data (the number of pieces of remaining processing) based on the processing target node data. Details are explained with reference to FIGS. 8A, 8B, 9A and 9B.

Specifically, the parallel processing management apparatus in this embodiment performs data processing for processing target node data and calculates, on the basis of the number of stages and the number of branches of processed node data and the processing target node data, a total number of node data linked to start node data. On the basis of propagate information concerning the processed node data and information concerning the processing target node data, the parallel processing management apparatus can estimate a total number of node data linked to the start node data. The total number of node data is the number of processing target data (hereinafter referred to as total number of pieces of processing). The number of stages of node data indicates, for example, a distance from the start node data.

Further, when the total number of pieces of processing exceeds a reference number, the parallel processing management apparatus sets, as a target of the parallel processing, processing for node data branching from the processing target node data. When the total number of pieces of data processing is large, the parallel processing management apparatus can suppress imbalance of a processing time among pieces of data processing by setting processing of a part of node data as a target of parallelization.

FIGS. 8A and 8B are diagrams for explaining an application example of the parallel processing for data processing based on a total number of pieces of processing. Tree structures are the same as the tree structures in the examples illustrated in FIGS. 6A, 6B, 7A and 7B. In the example illustrated in FIGS. 8A and 8B, for example, when the total number of pieces of processing is equal to or larger than ten, the parallel processing management system sets processing of node data branching to three or more node data as a target of parallelization.

In the example illustrated in FIG. 8A, it is assumed that a total number of pieces of processing estimated by the parallel processing management apparatus 10 in processing the node data DnD is a value equal to or larger than ten. Since the node data DnD branches to three node data JnJ to LnL, the parallel processing management apparatus 10 sets processing for the three node data JnJ to LnL as a target of the parallel processing. When the processing of the node data JnJ to LnL is parallelized, parallelism is 3 and a processing time is 12. As illustrated in FIG. 8A, the parallel processing management apparatus 10 improves throughput (15 to 12) by setting processing of a part of node data as a target of the parallel processing.

In the example illustrated in FIG. 8B, it is assumed that a total number of pieces of processing estimated by the parallel processing management apparatus 10 is always smaller than ten. Therefore, the parallel processing management apparatus 10 does not set processing of the node data PnP to XnX as a target of the parallel processing. When the node data PnP to XnX are subjected to the serial processing, a processing time is 9. As illustrated in FIG. 8B, the parallel processing management apparatus 10 reduces a consumed amount of resources and avoids oppression of resources by not applying parallelization to data processing with a short processing time.

As illustrated in FIGS. 8A and 8B, the parallel processing management apparatus 10 can improve imbalance of the processing time and avoid depletion of resources by determining presence or absence of parallelization for data processing on the basis of the total number of pieces of processing.

FIGS. 9A and 9B are diagrams for explaining an example of a reduction of a turnaround time of data processing based on a total number of pieces of processing. The turnaround time indicates time from the start to the end of the data processing. In FIGS. 9A and 9B, data processing X, a total number of pieces of processing of which is ten, and data processing Y, a total number of pieces of processing of which is three, are illustrated. In the example illustrated in FIGS. 9A and 9B, the parallel processing management system does not process a plurality of pieces of data processing in parallel.

FIG. 9A illustrates an example in which data processing is sequentially scheduled according to arrival order. The data processing X starts at time 0 and ends at time 10. In this case, a turnaround time of the data processing X is 10 (time 0 to time 10). The data processing Y starts at time 1. However, since the data processing Y is not executed during execution of the data processing of the data processing X, the data processing Y starts at time 10, when the data processing X ends, and ends at time 13. In this case, a turnaround time of the data processing Y is 12 (time 1 to time 13). Therefore, an average of the turnaround times of the data processing X and the data processing Y is 11 (=(10+12)/2).

On the other hand, FIG. 9B illustrates an example in which data processing is sequentially scheduled according to the remaining processing time based on a total number of pieces of processing. The remaining processing time is calculated by subtracting the number of processed node data from a calculated total number of pieces of processing. In the example illustrated in FIG. 9B, the parallel processing management system preferentially executes data processing with a short processing time to thereby reduce the average of the turnaround times.

Specifically, in FIG. 9B, the data processing X starts at time 0. However, the processing is suspended in response to arrival of the data processing Y, which has a shorter remaining processing time than the data processing X, at time 1. The data processing Y starts at time 1 and ends at time 4. When the data processing Y ends, the suspended data processing X resumes and ends at time 13. In FIG. 9B, a turnaround time of the data processing X is 13 (time 0 to time 13). A turnaround time of the data processing Y is 3 (time 1 to time 4). Therefore, an average of the turnaround times of the data processing X and the data processing Y is 8 (=(13+3)/2).

As illustrated in FIGS. 9A and 9B, the parallel processing management system can reduce an average of turnaround times of data processing (11 to 8) by controlling execution of the data processing according to the remaining processing time based on the total number of pieces of processing.

A flow of processing in the parallel processing management system in this embodiment is explained.

[Flowchart]

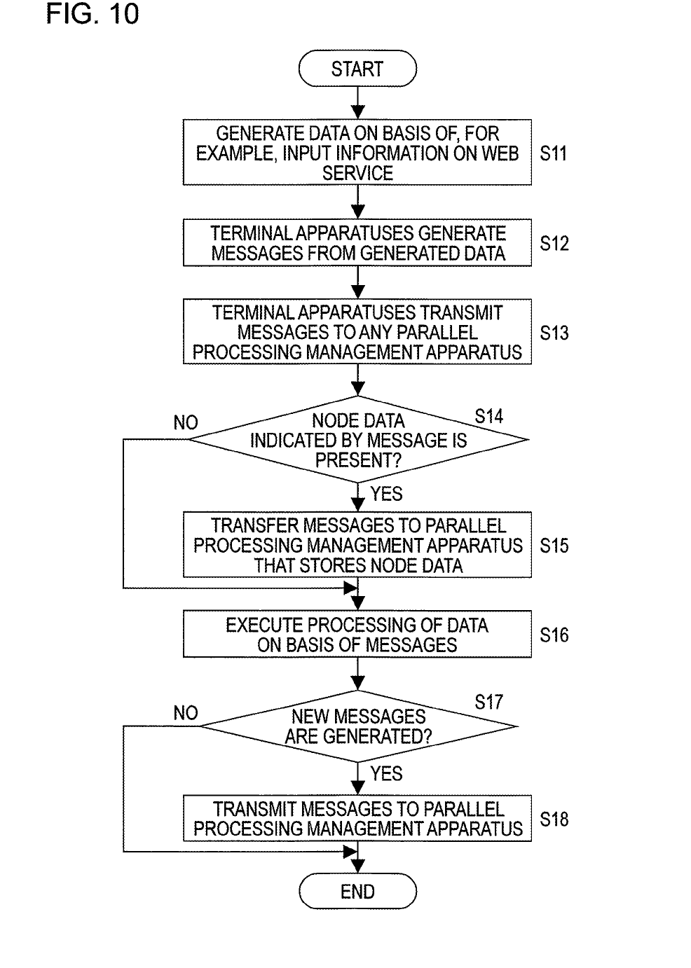

FIG. 10 is a flowchart for explaining data processing executed by being triggered by data generation in the terminal apparatuses 30a to 30c illustrated in FIG. 1. First, the terminal apparatuses 30a to 30c generate data on the basis of, for example, an input of information on a Web service (S11). Subsequently, the terminal apparatuses 30a to 30c generate messages on the basis of the generated data (S12). Specifically, the terminal apparatuses 30a to 30c generate messages including keys (node data names, etc.) for uniquely identifying processing target data (hereinafter referred to as node data) and function names representing processing contents.

Subsequently, the terminal apparatuses 30a to 30c transmit the generated messages to any parallel processing management apparatus 10 through a network (S13). The terminal apparatuses 30a to 30c transmit the generated messages to any one of the parallel processing management apparatuses 10. The message control unit 24 of the incremental processing engine 21 of the parallel processing management apparatus 10, which receives the messages, analyzes the messages and determines, on the basis of key information included in the messages, whether the processing target node data is stored in the data storing unit 20 of the parallel processing management apparatus 10 (S14).

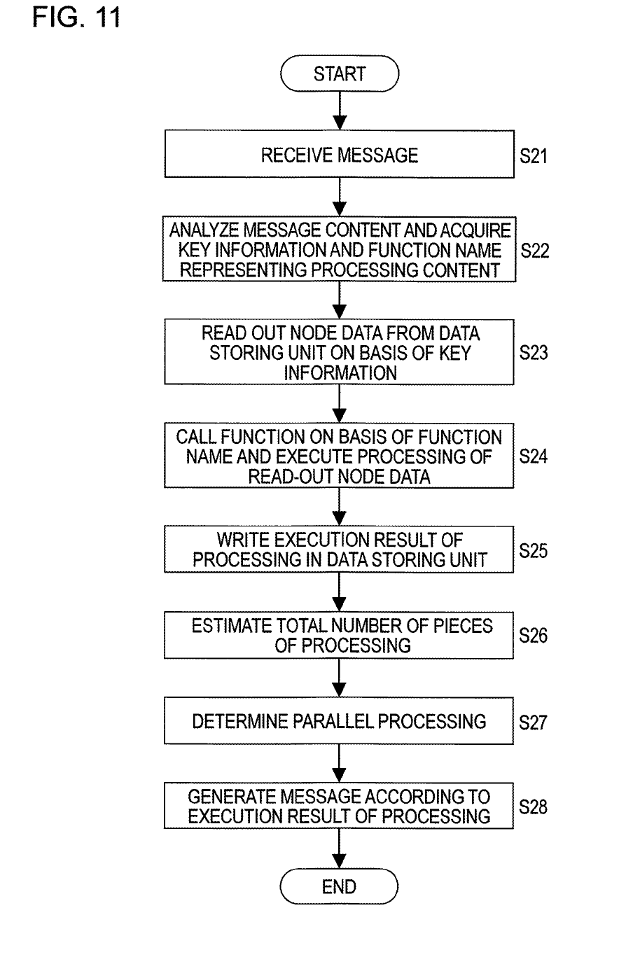

When the processing target node data is not stored in the data storing unit 20 of the parallel processing management apparatus 10 (NO in S14), the message control unit 24 transmits, on the basis of an address, a message to the parallel processing management apparatus 10 that stores the processing target node data in the data storing unit 20 (S15). The data processing unit 22 of the incremental processing engine 21 of the parallel processing management apparatus 10, which stores the processing target node data in the data storing unit 20, performs node data processing on the basis of the message (S16). Details of the processing is explained below with reference to a flowchart of FIG. 11.

When one or more messages are generated as a result of the processing in step S16 (YES in S17), the message control unit 24 of the incremental processing engine 21 of the parallel processing management apparatus 10 transmits, on the basis of the key information included in the message, the generated message to the parallel processing management apparatus 10 that stores the node data in the data storing unit 20 (S18).

The processing of the incremental processing engine 21 in the parallel processing management apparatuses 10 in the flowchart of FIG. 10 (S16 in FIG. 10) is explained with reference to a flowchart.

FIG. 11 is a flowchart for explaining processing of the data processing unit 22 of the incremental processing engine 21. The data processing unit 22 of the incremental processing engine 21 receives a message from the terminal apparatuses 30a to 30c or the incremental processing engines 21 of the other parallel processing management apparatuses 10 (S21).

Upon receiving the message, the data processing unit 22 analyzes the message and acquires key information indicating processing target node data and a function name representing processing content (S22). Subsequently, the data processing unit 22 reads out the processing target node data from the data storing unit 20 on the basis of the key information (S23). The data processing unit 22 calls a function on the basis of the acquired function name and applies processing to the read-out node data (S24). The data processing unit 22 writes an execution result of the processing in the data storing unit 20 (S25).

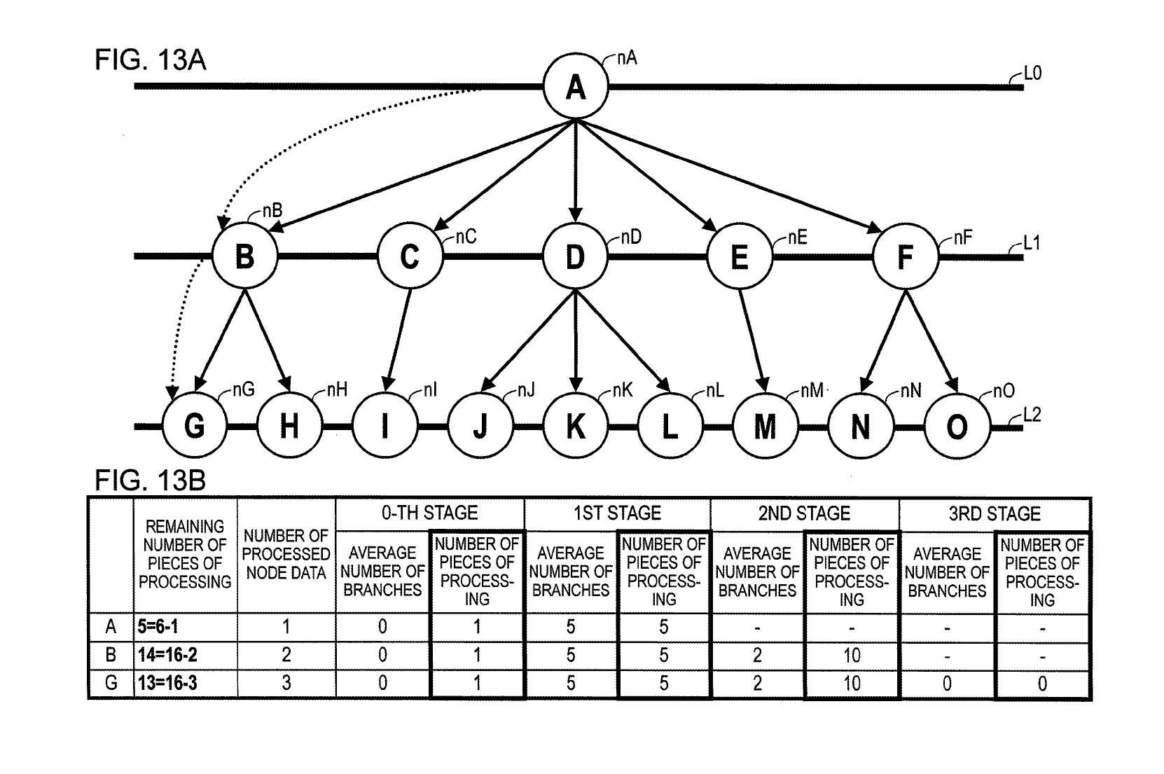

The data processing unit 22 calculates, on the basis of number of pieces of processing estimation information included in the message, a total number of node data linked to start node data and performs estimation of a total number of pieces of processing (S26). Details of estimation processing for a total number of pieces of processing are explained below with reference to FIGS. 13 to 15.

The data processing unit 22 determines, on the basis of the calculated total number of pieces of processing, whether processing for node data branching from the processing target node data is set as a target of parallelization (S27). Subsequently, the data processing unit 22 generates a message of the node data branching from the processing target node data and transmits a message to the parallel processing management apparatus 10 that retains node data to be set as a processing target next (S28). In this case, when the following node data is a target of the parallel processing, the data processing unit 22 transmits the message to the plurality of parallel processing management apparatuses 10.

An overview of propagation of a message between the parallel processing management apparatuses 10 in the data processing explained with reference to the flowcharts of FIGS. 10 and 11 is explained.

[Flow of Message Propagation]

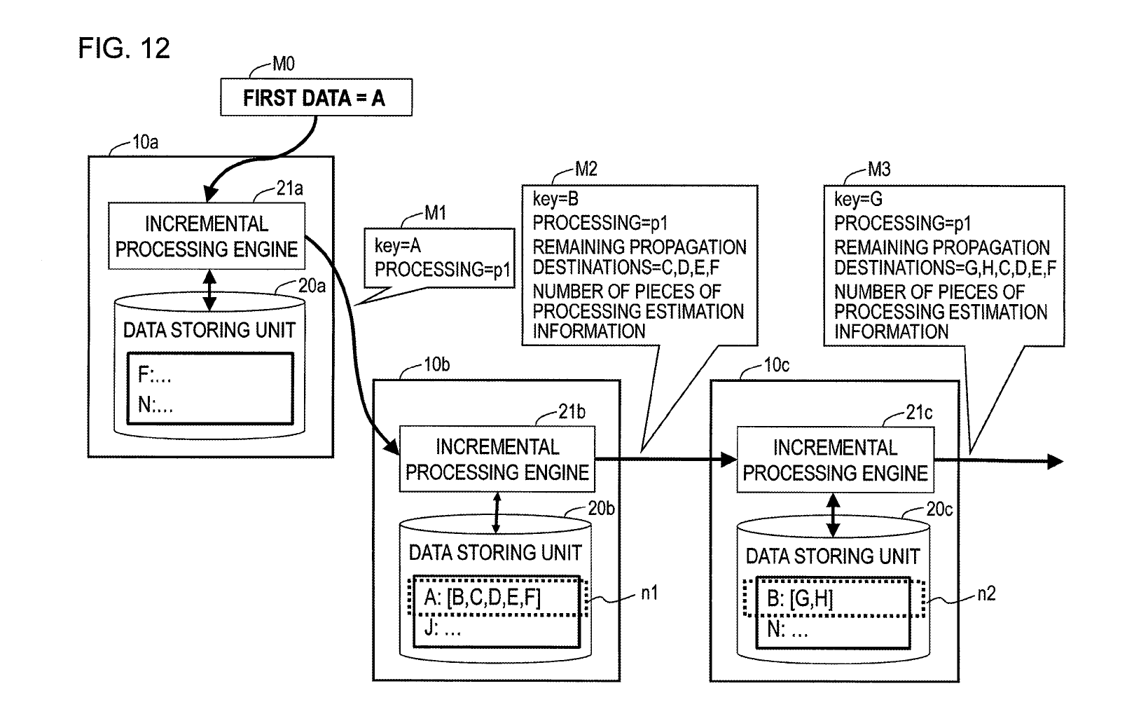

FIG. 12 is a diagram for explaining the overview of propagation of a message between the parallel processing management apparatuses 10 in the data processing explained with reference to the flowcharts of FIGS. 10 and 11. First, the parallel processing management apparatus 10a receives a message M0 including information concerning processing target node data (node data A) from the terminal apparatuses 30a to 30c (S21 in FIG. 11).

In an example illustrated in FIG. 12, the data storing unit 20a of the parallel processing management apparatus 10a does not retain the node data A. Therefore, the incremental processing engine 21a of the parallel processing management apparatus 10a transmits a message M1 to the parallel processing management apparatus 10b that retains the node data A. In this case, the message M1 includes information indicating the processing target node data A (Key=A) and processing content p1 for node data.

Note that the incremental processing engine 21 may include, for example, a correspondence table of node data and the parallel processing management apparatuses 10, which retain the node data, and detect, referring to the correspondence table, the parallel processing management apparatus 10 that retains the node data. In this case, the parallel processing management apparatuses 10 respectively retain correspondence tables.

Alternatively, the incremental processing engine 21 may calculate a hash value of a node data ID or the like capable of uniquely identifying node data and detect, on the basis of the calculated hash value, the parallel processing management apparatus 10 that retains the node data.

For example, the incremental processing engine 21 detects, on the basis of a remainder obtained by dividing the hash value of the node data ID by the number of the parallel processing management apparatuses 10, the parallel processing management apparatus 10 that retains the node data. It is assumed that the hash value of the node data ID is “105” and the number of the parallel processing management apparatuses 10 is “10”. In this case, the parallel processing management apparatus 10 corresponding to an identification number of a remainder “5 (=105/10)” obtained by dividing the hash value by the number of the parallel processing management apparatuses 10 corresponds to the parallel processing management apparatus 10 that retains the node data having the node data ID. That is, the node data ID is given to the node data retained by the parallel processing management apparatus 10 corresponding to the identification number 5 such that a remainder obtained by dividing the hash value by “10” is “5”.

Referring back to FIG. 12, the incremental processing engine 21b of the parallel processing management apparatus 10b analyzes the received message M1 and specifies the processing target node data A and the processing content p1 for the node data A (S22). The incremental processing engine 21b accesses the data storing unit 20b and acquires the node data A and information (node data B to node data F) n1 concerning connection destinations (branching destinations) of the node data A. The incremental processing engine 21b executes the processing p1 on the node data A (S23 and S24). The incremental processing engine 21b writes a result of the processing p1 for the node data A in the data storing unit 20b of the parallel processing management apparatus 10b (S25).

The incremental processing engine 21b calculates, on the basis of the number of pieces of processing estimation information, a total number of node data linked to the node data A and performs estimation of a total number of pieces of processing (S26). In this case, the number of pieces of processing estimation information includes the number of stages of the node data A and the number of branches from the node data A. Details of estimation processing for a total number of pieces of processing are explained below with reference to FIGS. 13 to 15.

Subsequently, the incremental processing engine 21b generates messages of the node data B to the node data F, which are branching destination of the node data A, and transmits a message M2 to the parallel processing management apparatus 10c that retains the node data B to be set as a processing target next (S28). The message M2 includes information indicating the processing target node data B (Key=B), the processing content p1 for node data, information concerning the remaining node data (node data C to F), and the number of pieces of processing estimation information.

Similarly, the incremental processing engine 21c of the parallel processing management apparatus 10c analyzes the received message M2 and specifies the processing target node data B and the processing content p1 for the node data B (S22). The incremental processing engine 21c accesses the data storing unit 20c and acquires the node data B and information (node data G and node data H) n2 concerning connection destinations (branching destinations) of the node data B and executes the processing p1 on the node data B (S23 and S24). The incremental processing engine 21c then writes a result of the processing p1 for the node data B in the data storing unit 20c of the incremental processing engine 21c (S25).

The incremental processing engine 21c calculates, on the basis of the number of pieces of processing estimation information, a total number of node data linked to the node data A and performs estimation of a total number of pieces of processing (S26). In this case, the number of pieces of processing estimation information includes the numbers of stages of the node data A and B and the numbers of branches from the node data A and B. The incremental processing engine 21c generates messages of the node data G and the node data H, which are branching destinations of the node data B, and transmits a message M3 to the parallel processing management apparatus 10 that retains the node data G to be set as a processing target next (S28).

The processing explained with reference to FIG. 12 is repeated until an end condition is satisfied. The end condition is set according to, for example, content of data processing. The end condition means that, for example, a predetermined variable is equal to or smaller than a threshold or the number of branches from the start node data reaches a threshold. Information concerning the end condition is included in, for example, processing content of the messages (in the example illustrated in FIG. 12, the processing p1).

### SPECIFIC EXAMPLES

FIGS. 13A and 13B are a first diagram for explaining a specific example of estimation processing for a total number of node data in this embodiment. In the specific example, processing is applied to the fifteen node data AnA to OnO starting from the node data AnA. In the example illustrated in FIG. 13A, related node data are traced in a depth first manner.

A determination condition for the parallel processing in the specific example is “a total number of node data is equal to or larger than ten and the number of branches is equal to or larger than three”. For example, after reaching a leaf (a terminal end) of a tree structure, when a total number of node data calculated by the estimation processing for a total number of node data is equal to or larger than ten and the number of branches obtained from processing target node data is equal to or larger than three, the parallel processing management apparatus 10 sets, as a target of parallelization, processing for node data branching from the processing target node data.

### Specific Example: Node Data A

In the specific example, node data corresponding to start node data is the node data AnA. As explained with reference to the flowcharts of FIGS. 11 and 12, the incremental processing engine 21 of the parallel processing management apparatus 10 applies processing to the node data AnA (S22 to S25 in FIG. 11) and performs, on the basis of the number of pieces processing estimation information, estimation processing for a total number of node data linked to the start node data, that is, a total number of pieces of processing (S26).

Specifically, the incremental processing engine 21 accesses the node data AnA in the data storing unit 20, acquires node data (the node data BnB to the node data FnF) at connection destinations of the node data AnA, and acquires the number of branches “5” from the node data AnA. Therefore, the incremental processing engine 21 assumes that the number of branches from a zero-th stage L0 to a first stage L1 is “5”, and calculates the number of node data “5” in the first stage L1. The number of node data in the zero-th stage L0, to which the node data AnA serving as the start node data belongs, is “1”.

The incremental processing engine 21 adds up the numbers of node data in the zero-th stage L0 and the first stage L1 and calculates a total number of node data 6 (=1+5). In this case, since the node data AnA is already processed, the incremental processing engine 21 subtracts the number of processed node data “1” from the total number of node data “6” and calculates the number of unprocessed node data “5 (=6-1)”.

Subsequently, the incremental processing engine 21 generates a message of five node data at the branching destination of the node data AnA and transmits the message to the parallel processing management apparatus 10 that retains node data to be set as a processing target next (S28 in FIG. 11). As explained above, in the specific example, the node data is sequentially traced in a depth first manner. Therefore, the incremental processing engine 21 transmits the message to the parallel processing management apparatus 10 that retains the node data BnB.

### Specific Example: Node Data B

The incremental processing engine 21 of the parallel processing management apparatus 10, which receives the message, applies processing to the node data BnB (S22 to S25 in FIG. 11) and performs, on the basis of the number of pieces of processing estimation information, estimation processing for a total number of node data linked to the start node data A, that is, a total number of pieces of processing (S26).

Specifically, the incremental processing engine 21 accesses the node data BnB in the data storing unit 20 and acquires node data (the node data GnG and the node data HnH) at connection destinations of the node data BnB and the number of branches “2” from the node data BnB. Therefore, the incremental processing engine 21 assumes that the number of branches from the first stage L1 to a second stage L2 is “2”, multiplies together the number of node data “5” in the first stage L1 and the number of branches “2” from the first stage L1 to the second stage L2 and calculates the number of node data “10 (=5×2)” in the second stage L2.

The incremental processing engine 21 adds up the numbers of node data in the zero-th stage L0 to the second stage L2 and calculates a total number of node data “16 (=1+5+10)”. In this case, since the node data AnA and BnB are already processed, the incremental processing engine 21 subtracts the number of processed node data “2” from the total number of node data “16” and calculates the number of unprocessed node data “14 (=16-2)”.

Subsequently, the incremental processing engine 21 generates a message of two node data at branching destinations of the node data BnB and transmits a message to the parallel processing management apparatus 10 that retains the node data GnG to be set as a processing target next (S28 in FIG. 11).

### Specific Example: Node Data G

The incremental processing engine 21 of the parallel processing management apparatus 10, which receives the message, applies processing to the node data GnG (S22 to S25 in FIG. 11) and performs, on the basis of the number of pieces of processing estimation information, estimation processing for a total number of node data linked to the start node data A, that is, a total number of pieces of processing (S26).

Specifically, the incremental processing engine 21 accesses the node data GnG in the data storing unit 20 and acquires node data (no connection destinations) at connection destinations of the node data GnG and the number of branches “0” from the node data GnG. Therefore, the incremental processing engine 21 assumes that the number of branches from the second stage L2 to a third stage is “0” and calculates the number of node data “0” in the third stage.

The incremental processing engine 21 adds up the numbers of node data in the zero-th stage L0 to the second stage L2 and calculates a total number of node data “16 (=1+5+10)”. In this case, since the node data AnA and BnB are already processed, the incremental processing engine 21 subtracts the number of processed node data “3” from the total number of node data “16” and calculates the number of unprocessed node data “13 (=16-3)”.

Since the processing target node data reaches the leaf, the incremental processing engine 21 determines, on the basis of the calculated total number of pieces of processing, whether processing for node data branching from the processing target node data is set as a target of parallelization (S27 in FIG. 11). Specifically, when the calculated total number of pieces of processing is equal to or larger than ten and the number of branches from the processing target node data is equal to or larger than three, the incremental processing engine 21 sets, as a target of parallelization, processing for node data branching from the processing target node data. In this case, since the node data GnG is node data of the leaf that does not branch, the incremental processing engine 21 does not set the following processing as a target of parallelization.

Subsequently, the incremental processing engine 21 transmits a message to the incremental processing engine 21 of the parallel processing management apparatus 10 that retains the node data HnH to be set as a processing target next (S28).

As explained with reference to FIG. 13A and FIG. 13B, the parallel processing management apparatus 10 in this embodiment propagates the number of stages and the number of branches of the processed node data to node data to be set as a processing target next time. The parallel processing management apparatus 10 can estimate a total number of pieces of processing of data processing even halfway in the data processing on the basis of the number of stages and the number of branches of the propagated processed node data and the number of stages and the number of branches of the processing target node data.

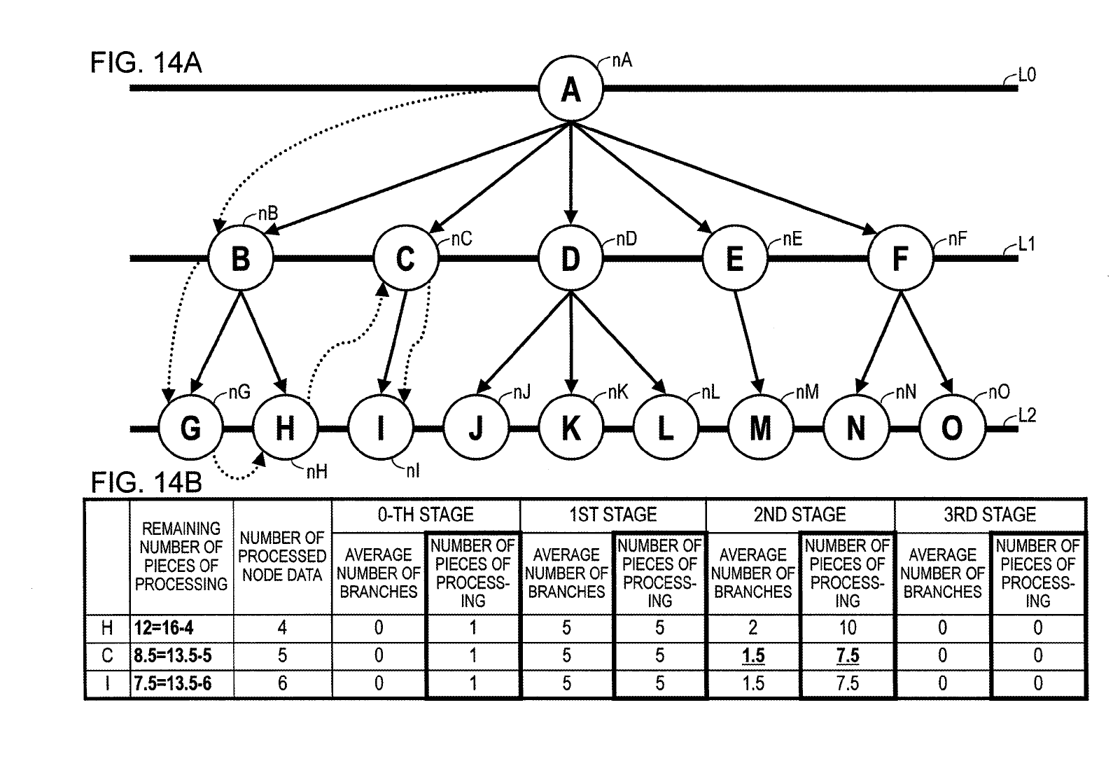

FIGS. 14A and 14B are a second diagram for explaining the specific example of the estimation processing for a total number of node data in this embodiment.

### Specific Example: Node Data H

Similarly, the incremental processing engine 21 of the parallel processing management apparatus 10, which receives the message, applies processing to the node data HnH (S22 to S25 in FIG. 11) and performs, on the basis of the number of pieces of processing estimation information, estimation processing for a total number of node data linked to the start node data A, that is, a total number of pieces of processing (S26).

Specifically, the incremental processing engine 21 accesses the node data HnH in the data storing unit 20 and acquires node data (no connection destinations) at connection destinations of the node data HnH and the number of branches “0” from the node data HnH. Therefore, the incremental processing engine 21 assumes that the number of branches from the second stage L2 to the third stage is “0” and calculates the number of node data “0” in the third stage.

The incremental processing engine 21 adds up the numbers of node data in the zero-th stage L0 to the second stage L2 and calculates a total number of node data “16 (=1+5+10)”. In this case, since the node data AnA, BnB, GnG, and HnH are already processed, the incremental processing engine 21 subtracts the number of processed node data “4” from the total number of node data “16” and calculates the number of unprocessed node data “12=(16-4)”.

Since the number of branches from the node data H is smaller than three, the incremental processing engine 21 does not set the following processing as a target of parallelization. Subsequently, the incremental processing engine 21 transmits a message to the incremental processing engine 21 of the parallel processing management apparatus 10 that retains the node data CnC to be set as a processing target next (S28).

### Specific Example: Node Data C

Similarly, the incremental processing engine 21 of the parallel processing management apparatus 10, which receives the message, applies processing to the node data CnC (S22 to S25 in FIG. 11) and performs, on the basis of the number of pieces of processing estimation information, estimation processing for a total number of node data linked to the start node data A, that is, a total number of pieces of processing (S26). Specifically, the incremental processing engine 21 accesses the node data CnC in the data storing unit 20 and acquires node data (the node data InI) at a connection destination of the node data CnC and the number of branches “1” from the node data CnC.

The number of branches from the node data BnB belonging to the first stage L1 like the node data CnC is “2”. Therefore, the incremental processing engine 21 assumes that the number of branches from the first stage L1 to the second stage L2 is an average “1.5=((2+1)/2)”, multiplies together the calculated number of node data “5” in the first stage L1 and the number of branches “1.5” from the first stage L1 to the second stage L2, and calculates the number of node data “7.5 (=5×1.5)” in the second stage L2. The incremental processing engine 21 adds up the numbers of node data in the zero-th stage L0 to the second stage L2 and calculates a total number of node data “13.5 (=1+5+7.5)”. In this case, since the node data AnA, BnB, GnG, HnH, and CnC are already processed, the incremental processing engine 21 subtracts the number of processed node data “5” from the total number of node data “13.5” and calculates the number of unprocessed node data “8.5 (=13.5-5)”.

Since the number of branches from the processing target node data CnC is smaller than three, the incremental processing engine 21 does not set the following processing as a target of parallelization. Subsequently, the incremental processing engine 21 transmits a message to the incremental processing engine 21 of the parallel processing management apparatus 10 that retains the node data InI to be set as a processing target next (S28).

### Specific Example: Node Data I

Similarly, the incremental processing engine 21 of the parallel processing management apparatus 10, which receives the message, applies processing to the node data InI (S22 to S25 in FIG. 11) and performs, on the basis of the number of pieces of processing estimation information, estimation processing for a total number of node data linked to the start node data A, that is, a total number of pieces of processing (S26).

Specifically, the incremental processing engine 21 accesses the node data InI in the data storing unit 20 and acquires node data (no connection destinations) at connection destinations of the node data InI and the number of branches “0” from the node data InI. Therefore, the incremental processing engine 21 assumes that the number of branches from the second stage L2 to the third stage is “0” and calculates the number of node data “0” in the third stage.

The incremental processing engine 21 adds up the numbers of node data in the zero-th stage L0 to the second stage L2 and calculates a total number of node data “13.5 (=1+5+7.5)”. In this case, since the node data AnA, BnB, GnG, HnH, CnC, and InI are already processed, the incremental processing engine 21 subtracts the number of processed node data “6” from the total number of node data “13.5” and calculates the number of unprocessed node data “7.5=(13.5-6)”.

Since the node data InI is node data of the leaf that does not branch, the incremental processing engine 21 does not set the following processing as a target of parallelization. Subsequently, the incremental processing engine 21 transmits a message to the incremental processing engine 21 of the parallel processing management apparatus 10 that retains the node data DnD to be set as a processing target next (S28).

As explained with reference to FIG. 14A and FIG. 14B, the parallel processing management apparatus 10 in this embodiment recalculates a total number of pieces of processing on the basis of the number of stages and the number of branches of the processing target node data in addition to the number of stages and the number of branches of the propagated processed node data. That is, when the numbers of branches of the numbers of stages based on the processed node data and the numbers of branches of the numbers of stages based on the processing target node data are different, the parallel processing management apparatus 10 recalculates a total number of pieces of processing on the basis of the number of stages and the number of branches of the processing target node data. Therefore, since the parallel processing management apparatus 10 recalculates a total number of pieces of processing on the basis of the latest information, it is possible to correct the total number of pieces of processing and reduce an error. Therefore, the parallel processing management apparatus 10 can acquire, at an earlier stage, a total number of pieces of processing at higher accuracy.

The parallel processing management apparatus 10 in this embodiment recalculates a total number of pieces of processing on the basis of the number of stages and the number of branches of the processing target node data in addition to the number of stages and the number of branches of the propagated processed node data. Therefore, even when the number of branches of the processing target node data is not fixed, it is possible to gradually increase accuracy of a total number of pieces of processing.

The parallel processing management system in this embodiment traces related node data in a depth first manner. By tracing the related node data in a depth first manner, the parallel processing management system reaches node data of a leaf early. Therefore, the parallel processing management system can acquire the numbers of branches of all the numbers of stages in a tress structure at an early stage. Therefore, the parallel processing management apparatus 10 can estimate a total number of pieces of processing at an early stage of a process of data processing.

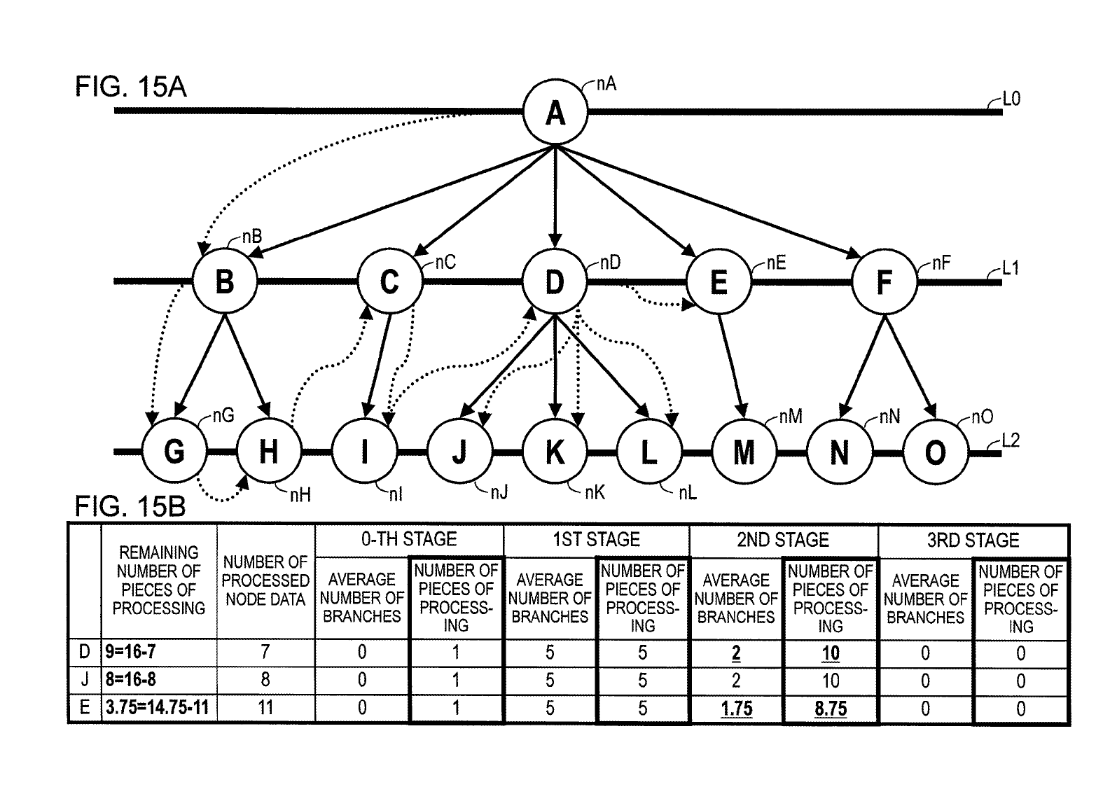

FIGS. 15A and 15B are a third diagram for explaining the specific example of the estimation processing for a total number of node data in this embodiment.

### Specific Example: Node Data D

Similarly, the incremental processing engine 21 of the parallel processing management apparatus 10, which receives the message, applies processing to the node data DnD (S22 to S25 in FIG. 11) and performs, on the basis of the number of pieces of processing estimation information, estimation processing for a total number of node data linked to the start node data A, that is, a total number of pieces of processing (S26).

Specifically, the incremental processing engine 21 accesses the node data DnD in the data storing unit 20 and acquires node data (the node data JnJ to LnL) at connection destinations of the node data DnD and the number of branches “3” from the node data DnD. Therefore, the incremental processing engine 21 assumes that the number of branches from the first stage L1 to the second stage L2 is an average “2=((2+1+3)/2)”, multiplies together the calculated number of node data “5” in the first stage L1 and the number of branches “2” from the first stage L1 to the second stage L2, and calculates the number of nodes “10 (=5×2)” in the second stage L2.

The incremental processing engine 21 adds up the numbers of node data in the zero-th stage L0 to the second stage L2 and calculates a total number of node data “16 (=1+5+10)”. In this case, since the node data AnA, BnB, GnG, HnH, CnC, InI, and DnD are already processed, the incremental processing engine 21 subtracts the number of processed node data “7” from the total number of node data “16” and calculates the number of unprocessed node data “9=(16−7)”.

Since the total number of pieces of processing is equal to or larger than ten and the number of branches from the processing target node data DnD is equal to or larger than three, the incremental processing engine 21 sets processing of the node data JnJ to LnL as a target of parallelization. Therefore, the incremental processing engine 21 transmits messages respectively to the incremental processing engines 21 of the parallel processing management apparatuses 10 that retain the node data JnJ, the node data KnK, and the node data LnL to be set processing targets next (S28).

### Specific Example: Node Data J

Processing of the node data JnJ is explained. However, processing of the node data KnK and the node data LnL is the same as the processing of the node data JnJ. Similarly, the incremental processing engine 21 of the parallel processing management apparatus 10, which receives the message, applies processing to the node data JnJ (S22 to S25 in FIG. 11) and performs, on the basis of the number of pieces of processing estimation information, estimation processing for a total number of node data linked to the start node data A, that is, a total number of pieces of processing (S26).

Specifically, the incremental processing engine 21 accesses the node data JnJ in the data storing unit 20 and acquires node data (no connection destinations) at connection destinations of the node data JnJ and the number of branches “0” from the node data JnJ. Therefore, the incremental processing engine 21 assumes that the number of branches from the second stage L2 to the third stage is “0” and calculates the number of node data “0” in the third stage.

The incremental processing engine 21 assumes that the number of branches from the second stage L2 to the third stage is “0” and calculates the number of node data “0” in the third stage. The incremental processing engine 21 adds up the numbers of node data in the zero-th stage L0 to the second stage L2 and calculates a total number of node data “16 (=1+5+10)”. In this case, since the node data AnA, BnB, GnG, HnH, CnC, InI, DnD, and JnJ are already processed, the incremental processing engine 21 subtracts the number of processed node data “8” from the total number of node data “16” and calculates the number of unprocessed node data “8=(16-8)”.

Since the node data JnJ is node data of the leaf that does not branch, the incremental processing engine 21 does not set the following processing as a target of parallelization. Since connection destinations of the node data JnJ are absent, the incremental processing engine 21 does not transmit a message.

### Specific Example: Node Data E

The incremental processing engine 21 of the parallel processing management apparatus 10, which receives the message from the parallel processing management apparatus 10 that retains the node data D, applies processing to the node data EnE (S22 to S25 in FIG. 11) and performs, on the basis of the number of pieces of processing estimation information, estimation processing for a total number of node data linked to the start node data A, that is, a total number of pieces of processing (S26).

Specifically, the incremental processing engine 21 accesses the node data EnE in the data storing unit 20 and acquires node data (node data MnM) at a connection destination of the node data EnE and the number of branches “1” from the node data EnE. Therefore, the incremental processing engine 21 multiplies together a deemed number of node data “5” in the first stage L1 and an average “1.75=((2+1+3+1)/2)” of the numbers of branches from the first stage L1 to the second stage L2 and calculates the number of node data “8.75 (=5×1.75)” in the second stage L2.

The incremental processing engine 21 adds up the numbers of node data in the zero-th stage L0 to the second stage L2 and calculates a total number of node data “14.75 (=1+5+8.75)”. In this case, since the node data AnA, BnB, GnG, HnH, CnC, InI, BnB, JnJ to LnL, and EnE are already processed, the incremental processing engine 21 subtracts the number of processed node data “11” from the total number of node data “14.75” and calculates the number of unprocessed node data “3.75=(14.75−11)”.

Since the number of branches is smaller than three, the incremental processing engine 21 does not set processing for the node data MnM branching from the node data EnE as a target of parallelization (S27 in FIG. 11). Subsequently, the incremental processing engine 21 transmits a message to the incremental processing engine 21 of the parallel processing management apparatus 10 that retains the node data MnM to be set as a processing target next (S28). The following processing is the same as the processing explained with reference to FIGS. 13 to 15.

As explained with reference to FIG. 15A and FIG. 15B, when an estimated value of a total number of node data (a total number of pieces of processing) is equal to or larger than a reference value (in the example illustrated in FIG. 15A and FIG. 15B, ten), the parallel processing management apparatus 10 in this embodiment sets processing of node data at branching destinations of the processing target node data as a target of the parallel processing. Therefore, the parallel processing management apparatus 10 can narrow a difference in processing times between pieces of node data processing, which have different total numbers of pieces of processing, by setting node data processing having a large total number of pieces of processing as a target of the parallel processing and not parallelizing node data processing having a small number of pieces of processing. That is, the parallel processing management apparatus 10 can reduce a difference in processing times between pieces of node data processing, which have different total numbers of pieces of processing, by managing parallel processing target node data in data processing according to a total number of pieces of processing.

Note that, when the remaining number of pieces of processing is equal to or larger than a reference value, the parallel processing management apparatus 10 may set processing of node data at branching destinations of the processing target node data as a target of the parallel processing. Consequently, when the total number of pieces of processing is large and the remaining number of pieces of processing is large, the parallel processing management apparatus 10 can set unprocessed node data processing as a target of the parallel processing.

When an estimated total number of kinds of processing is equal to or larger than a reference value and when the number of branches is equal to or larger than a reference number of branches (in the example illustrated in FIG. 15 A and FIG. 15B, three), the parallel processing management apparatus 10 in this embodiment sets processing of node data at branching destinations of the processing target node data as a target of the parallel processing. The parallel processing management system in this embodiment can more flexibly perform management of the parallel processing by further determining presence or absence of parallelization according to the number of branches.

Note that, in the examples illustrated in FIGS. 13 to 15, the parallel processing management system can control execution of data processing and perform control for reducing a turnaround time by further setting a target of the parallel processing on the basis of the remaining number of pieces of processing calculated from the total number of pieces of processing.

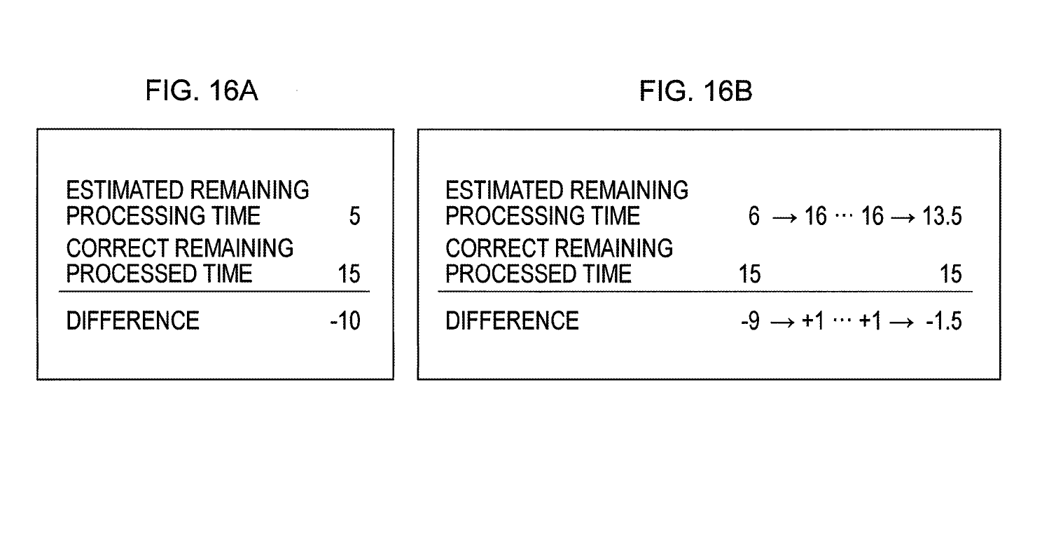

FIGS. 16A and 16B are diagrams for explaining transition of an estimated number of a total number of pieces of processing. FIG. 16A is a diagram for explaining a difference between the remaining number of pieces of processing obtained when a total number of pieces of processing is estimated on the basis of, for example, an average number of branches of node data and the depth of a tree structure and an actual remaining number of pieces of processing. In an example illustrated in FIG. 16A, for example, the remaining processing time calculated by estimation is 5. On the other hand, an actual remaining processing time is 15. Therefore, a difference between the remaining processing time by the estimation and the actual remaining processing time is −10.

On the other hand, FIG. 16B is a diagram for explaining a difference between the remaining number of pieces of processing estimated by the parallel processing management apparatus 10 in this embodiment on the basis of a total number of pieces of processing and an actual number of remaining pieces of processing. In this embodiment, the remaining processing time is recalculated every time processing of respective node data in data processing is performed. In an example illustrated in FIG. 16B, for example, the estimated remaining processing time transitions in such a manner as 6->16-> . . . ->16->13.5. On the other hand, an actual remaining processing time is 15. Therefore, an error between the remaining processing time estimated by the parallel processing management apparatus 10 in this embodiment and the actual remaining processing time transitions in such a manner as −9->+1-> . . . ->+1->−1.5. That is, the error between the remaining processing time estimated by the parallel processing management apparatus 10 in this embodiment and the actual remaining processing time gradually decreases.

As illustrated in FIGS. 16A and 16B, the parallel processing management apparatus 10 in this embodiment recalculates, every time data processing is performed, a total number of pieces of processing on the basis of the number of stages and the number of branches of the propagated processed node data and the number of stages and the number of branches of the processing target node data. Consequently, the parallel processing management apparatus 10 can correct the total number of pieces of processing and reduce an error. Therefore, the parallel processing management apparatus 10 can acquire a more highly accurate total number of pieces of processing at an earlier stage in a process of the data processing by recalculating, every time the data processing is performed, a total number of pieces of processing on the basis of latest information.

As explained above, the parallel processing management program in this embodiment includes managing a data processing by a processing target node among a plurality of nodes in which respective nodes have relations with other nodes, the processing target node being traced from a start node on the basis of the relations and calculating a total number of nodes linked to the start node on the basis of numbers of stages indicating distances of processed nodes and the processing target node from the start node, and numbers of branches from the processed nodes and the processing target node, while the processing target node performs the data processing.

With the parallel processing management program in this embodiment, a total number of pieces of processing is recalculated on the basis of the number of stages and the number of branches of the propagated processed node data and the number of stages and the number of branches of the processing target node data. Consequently, even during data processing, it is possible to estimate a total number of pieces of processing of the data processing. Therefore, with the parallel processing management program, even during the data processing, it is possible to control node data on the basis of the total number of pieces of processing.

With the parallel processing management program in this embodiment, every time data processing is performed, a total number of pieces of processing is recalculated on the basis of the number of stages and the number of branches of the propagated and accumulated processed node data and the number of stages and the number of branches of the processing target node data. Consequently, it is possible to correct the total number of pieces of processing and gradually reduce an error in a process of the data processing. Therefore, with the parallel processing management program in this embodiment, the total number of pieces of processing is recalculated on the basis of related information of the node data accumulated by propagation. Consequently, it is possible to obtain a highly accurate total number of pieces of processing at an earlier stage in the process of the data processing.

With the parallel processing management program in this embodiment, a total number of pieces of processing is estimated on the basis of the number of stages and the number of branches of the processed node data accumulated by propagation and the number of stages and the number of branches of the processing target node data. Consequently, even when the number of branches of the processing target node data is not fixed, it is possible to estimate a more highly accurate total number of pieces of processing.

In the managing of the parallel processing management program in this embodiment, further, when the calculated total number of nodes exceeds a reference number, processing for nodes branching from the processing target node is set as a target of the parallel processing.

With the parallel processing management program in this embodiment, when an estimated value of a total number of node data (a total number of pieces of processing) is equal to or larger than a reference value (in the example illustrated in FIG. 15 A and FIG. 15B, ten), processing of node data at branching destinations of the processing target node data is set as a target of the parallel processing. Consequently, it is possible to reduce a difference in processing times between pieces of node data processing, which have different total numbers of pieces of processing. Specifically, the parallel processing management program can narrow a difference in processing times between pieces of node data processing, which have different total numbers of pieces of processing, by setting node data processing having a large total number of pieces of processing as a target of the parallel processing and not parallelizing node data processing having a small number of pieces of processing.

In the managing of the parallel processing management program in this embodiment, further, when the number of branches from the processing target data exceeds a reference number of branches, processing for nodes branching from the processing target node is set as a target of the parallel processing. With the parallel processing management program in this embodiment, further, when the number of branches is equal to or larger than a reference number of branches (in the example illustrated in FIG. 15 A and FIG. 15B, three), processing of node data at branching destinations of the processing target node is set as a target of the parallel processing. Therefore, it is possible to determine presence or absence of parallelization corresponding to the number of branches and more flexibly perform management of the parallel processing.

In the calculating of the parallel processing management program in this embodiment, further, the number of unprocessed nodes is calculated on the basis of a calculated total number of nodes linked to a start node and the number of processed nodes. With the parallel processing management program in this embodiment, it is possible to specify the remaining processing time based on a total number of pieces of processing. Therefore, it is possible to reduce an average of turnaround times of data processing by controlling to execute the data processing on the basis of the remaining processing time calculated by the parallel processing management program.

In the process of the parallel processing management program in this embodiment, the numbers of stages and the numbers of branches of processed nodes are received from a previous processed node. The numbers of stages and the numbers of branches of the processed nodes and a processing target node added with the number of stages and the number of branches of the processing target node are transmitted to a next processing target node to be set as a processing target next time. With the parallel processing management program in this embodiment, the number of stages and the number of branches of the processed node data is propagated to node data to be set as a processing target next time. Consequently, even during data processing, it is possible to estimate a total number of pieces of processing of the data processing.

In the parallel processing management program in this embodiment, nodes are traced in a depth first manner from a start node on the basis of relations among nodes. With the parallel processing management program in this embodiment, since the nodes are traced in a depth first manner, it is possible to acquire the numbers of branches of all the numbers of stages in a tree structure at an early stage. Therefore, it is possible to estimate a total number of pieces of processing at an early stage of a process of data processing.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

1. A non-transitory computer-readable storage medium storing therein a program that causes a computer to execute a process comprising:
managing a data processing by a processing target node among a plurality of nodes in which respective nodes have relations with other nodes, the processing target node being traced from a start node on the basis of the relations, and
calculating a total number of nodes linked to the start node on the basis of numbers of stages indicating distances of processed nodes and the processing target node from the start node, and numbers of branches from the processed nodes and the processing target node, while the processing target node performs the data processing.

2. The non-transitory computer-readable storage medium storing therein the program according to claim 1, the managing further comprising:
setting processing for the nodes branching from the processing target node as a target of parallel processing, when the calculated total number of the nodes exceeds a reference number.

3. The non-transitory computer-readable storage medium storing therein the program according to claim 2, wherein
the setting further sets the processing for the nodes branching from the processing target node as the target of the parallel processing, when the number of branches from the processing target node exceeds a reference number of branches.

4. The non-transitory computer-readable storage medium storing therein the program according to claim 1, the calculating further comprising:
second calculating the number of unprocessed nodes on the basis of the calculated total number of the nodes linked to the start node and the number of processed nodes.

5. The non-transitory computer-readable storage medium storing therein the program according to claim 1, wherein
the calculating calculates the total number of the nodes linked to the start node by accumulating, on the basis of the numbers of stages and the numbers of branches of the processed nodes and the processing target node, the number of nodes of a second number of stages one order lower than a first number of stages, the number of nodes of the second number of stages being calculated by multiplying the number of nodes of the first number of stages by an average of numbers of branches from the respective nodes of the first number of stages.

6. The non-transitory computer-readable storage medium storing therein the program according to claim 1, the process further comprising:
receiving the numbers of stages and the numbers of branches of the processed nodes from a previous processed node, and transmitting, to a next processing target node to be set as a processing target next time, the numbers of stages and the numbers of branches of the processed nodes and the processing target node added with the number of stages and the number of branches of the processing target node.

7. The non-transitory computer-readable storage medium storing therein the program according to claim 1, wherein the nodes are traced in a depth first manner from the start node on the basis of the relations among the nodes.

8. A method for data processing, the method comprising:
managing the data processing by a processing target node among a plurality of nodes in which respective nodes have relations with other nodes, the processing target node being traced from a start node on the basis of the relations, and
calculating a total number of nodes linked to the start node on the basis of numbers of stages indicating distances of processed nodes and the processing target node from the start node, and numbers of branches from the processed nodes and the processing target node, while the processing target node performs the data processing.

9. The method according to claim 8, the managing further comprising:
setting processing for the nodes branching from the processing target node as a target of parallel processing, when the calculated total number of the nodes exceeds a reference number.

10. The method according to claim 8, the calculating further comprising:
second calculating the number of unprocessed nodes on the basis of the calculated total number of the nodes linked to the start node and the number of processed nodes.

11. A processing management apparatus comprising:
a management unit configured to manage a data processing by a processing target node among a plurality of nodes in which respective nodes have relations with other nodes, the processing target node being traced from a start node on the basis of the relations, and
a calculation unit configured to calculate a total number of nodes linked to the start node on the basis of numbers of stages indicating distances of processed nodes and the processing target node from the start node, and numbers of branches from the processed nodes and the processing target node, while the processing target node performs the data processing.

12. The processing management apparatus according to claim 11, wherein the management unit further sets processing for the nodes branching from the processing target node as a target of parallel processing, when the calculated total number of the nodes exceeds a reference number.

13. The parallel processing management apparatus according to claim 11, wherein the calculation unit further calculates the number of unprocessed nodes on the basis of the calculated total number of the nodes linked to the start node and the number of processed nodes.
